(19) United States
(12) Patent Application Publication
(10) Pub. No.: US 2004/0212124 A1
(43) Pub. Date: Oct. 28, 2004

(54) Process and apparatus for continuously producing a suction cupped sheet

(76) Inventor: Hiroshi Ishikawa, Osaka City (JP)

Correspondence Address: WENDEROTH, LIND & PONACK, L.L.P., 2033 K STREET N. W., SUITE 800, WASHINGTON, DC, 20006-1021, US

(21) Appl. No.: 10/828,348

(22) Filed: Apr. 21, 2004

(30) Foreign Application Priority Data
Apr. 28, 2003 (JP) 2003-123624

(51) Int. Cl. B29C 47/00

(52) U.S. Cl. 264/210.2; 425/505; 425/509; 425/515

(57) ABSTRACT

An apparatus according to the present invention continuously produces a suction cupped sheet of a predetermined width having a number of suction cups molded on a resin sheet. The apparatus has an endless track including an upper conveying path and includes a drawing mechanism. A thermoplastic soft resin is extruded sequentially into a train of molds conveyed along the conveying path. The extruded resin solidifies and forms a suction cupped sheet. The drawing mechanism draws the suction cupped sheet from the molds near the end point of the conveying path.

### BACKGROUND OF THE INVENTION

The present invention relates to a process and an apparatus for producing an ultra-long or endless suction cupped sheet of a predetermined width. In particular, the invention relates to a process and an apparatus for continuously molding a sheet of a predetermined width that is an elastomeric thermoplastic resin sheet with a large number of suction cups formed integrally on one of its sides.

Since the suction cupped sheet is not particularly limited in length, it is versatile and may be used as cushioning materials for glass and earthenware, protective materials for fragile products and parts on production lines, defrosters and sunshades for automobile windshields, and anti-slip sheets for adsorptive use on floors in hospitals, rehabilitation facilities and bathrooms.

The general process and apparatus for producing suction cupped sheets are a process and an apparatus for the injection molding from a soft resin such as a thermoplastic elastomer using molds in a regular shape. The injection molding process and apparatus are fully advantageous for some purposes. However, because the sheets are molded by injecting a soft resin into the molds in the regular shape and then cooling it to solidify it, the length and other dimensions of the molded sheets are limited. The maximum sheet length is about 1-2 meters.

Suction cupped sheets of 10 or more meters may be demanded. It may be demanded to produce a huge number of suction cup sheets at a relatively low cost. Production, delivery time and/or cost cutting may be prioritized for suction cupped sheets. In such cases, the injection molding process and apparatus are not suitable, but mass production is required.

The assignee's Japanese patent applications disclose processes and apparatus for continuously producing a honeycomb molding as a lawn protector for a lawn parking lot.

For example, Japanese Patent No. 3,343,514 (paragraphs 0024 and 0030, and FIG. 1) discloses a process and an apparatus for continuously producing a honeycomb molding from a hard resin. The honeycomb molding has a honeycomb array of polygonal tubes formed on a long plate. The polygonal tubes and the long plate are molded at the same time. The hard resin is injected from an extrusion type injector sequentially into molds, which are then moved horizontally. When the rein is almost solidified, the moving molds are lowered stepwise so as to be detached from the molding. Because the hard resin molding is open on one side and closed by the long plate on the other side, it is possible to remove the molds from the molding by moving them down away from the solidified long plate.

The process and apparatus disclosed in the Japanese patent are difficult to apply to mold a suction cupped sheet from an elastomeric soft resin, which may be a thermoplastic elastomer. If the dies for the suction cups were lowered stepwise to be removed from the molded sheet, it would be elastically pulled and hang down, following the dies, so that the molded cups would be difficult to draw from them.

### SUMMARY OF THE INVENTION

The object of the present invention is to provide a process and an apparatus for continuous mass production of a low-cost ultra-long or endless suction cupped sheet for a wide range of purposes from an elastomeric soft resin such as a thermoplastic elastomer.

In accordance with one aspect of the present invention, two processes are provided each for continuously producing a suction cupped sheet of a predetermined width with a number of suction cups on a resin sheet by means of an apparatus having an endless track, which includes an upper horizontal linear conveying path and a lower horizontal linear conveying path. The starting and end points of the upper conveying path are positioned over the end and starting points respectively of the lower conveying path. The apparatus includes molds movable along the endless track.

One of the processes comprises the steps of:

(1) extruding a thermoplastic soft resin in the form of a sheet sequentially into the molds being conveyed in the form of a train forward near the starting point of the upper conveying path;

(2) molding the extruded resin into a suction cupped sheet by conveying the molds forward along the upper conveying path until the extruded resin is solidified;

(3) drawing the suction cupped sheet sequentially from the molds near the end point of the upper conveying path to empty the molds;

(4) lowering the emptied molds sequentially from the end point of the upper conveying path to the starting point of the lower conveying path;

(5) returning the lowered molds from the starting point of the lower conveying path to the end point of the lower conveying path; and

(6) lifting the returned molds sequentially from to the end point of the lower conveying path to the starting point of the upper conveying path.

This process is to produce a suction cupped sheet including a base sheet that is open on one side and has a number of suction cups molded integrally at the same time on the base sheet and connected by this sheet. By extruding a thermoplastic soft resin in the form of a sheet from an extruder sequentially into the molds, it is possible to produce a continuous suction cupped sheet unlimited in length and having a predetermined width.

The suction cupped sheet may be used as a protective material for covering a steel plate on a car production line. The sheet may also be used as a cushioning material for covering a bathtub or earthenware being transported. The sheet may further be used on the floor of a bath room, with its back side serving for slip resistance. The sheet can be used for a wide variety of purposes and mass-produced at low cost.

The other process comprises the steps of:

(1) extruding different kinds of thermoplastic soft resin in the form of sheets sequentially into the molds to form a laminated sheet in the molds being conveyed in the form of a train forward through different points near the starting point of the upper conveying path;

(2) molding the laminated sheet into a suction cupped sheet by conveying the molds forward along the upper conveying path until the laminated sheet is solidified;

(3) drawing the suction cupped sheet sequentially from the molds near the end point of the upper conveying path to empty the molds;

(4) lowering the emptied molds sequentially from the end point of the upper conveying path to the starting point of the lower conveying path;

(5) returning the lowered molds from the starting point of the lower conveying path to the end point of the lower conveying path; and

(6) lifting the returned molds sequentially from to the end point of the lower conveying path to the starting point of the upper conveying path.

This suction cupped sheet consists of a cupped layer and one or more flat layers. The cupped layer has a number of suction cups molded on one side. The flat layer or one of the flat layers lies on the other side of the cupped layer. If the flat layer or outermost flat layer is hard, or if a reflecting agent is mixed with it, the suction cupped sheet can be used for a wider variety of purposes.

In accordance with another aspect of the present invention, an apparatus is provided for continuously producing a suction cupped sheet of a predetermined width with a number of suction cups on a resin sheet. The apparatus includes molds, a molder and an extruder. The molder has an endless track including a horizontal linear conveying path. The molder includes a mold conveyor for conveying the molds in the form of a train forward along the conveying path. The extruder includes a T-die for extruding a thermoplastic soft resin sequentially into the molds being conveyed along the conveying path. The T-die faces downward and is fitted over the conveying path near the starting point of the path. The molder molds the extruded resin into a suction cupped sheet by conveying the molds along the conveying path until the extruded resin is solidified. The apparatus also includes a forming roll, a drawing mechanism and a mold circulator. The forming roll is supported near and forward of the extruder. The forming roll forms the top of the extruded resin into a continuous surface and cools the resin. The drawing mechanism is fitted near the end point of the conveying path. The drawing mechanism draws the suction cupped sheet sequentially from the molds upward and backward to empty the molds while the molds are conveyed along the conveying path. The mold circulator circulates the emptied molds to the starting point of the conveying path.

This apparatus can reliably perform the foregoing processes and molds a suction cupped sheet by circulating the molds. Accordingly, the apparatus can simply produce a suction cupped sheet unlimited in length. Because the molds are easy to replace, the replacement of the molds makes it possible to simply produce suction cupped sheets of different sizes and/or pitches.

It is preferable that a temperature controller for heating the molds be fitted near the starting point of the conveying path. When the thermoplastic resin is extruded in the form of a sheet into the heated molds, the temperature difference between the resin and the molds is small. Accordingly, the extruded resin does not quickly solidify, but part of it flows smoothly into the mold cavities, so that the suction cupped sheet can be reliably molded.

The mold conveyor may include parallel rails and a guide rail all extending along the conveying path. The conveyor may also include a drive gear supported near the starting point of the conveying path. Each of the molds may include wheels, a guide and a rack. The wheels are supported at least on both sides of the mold bottom and run on the parallel rails. The guide is fixed to the mold bottom, extends between its front and rear ends, and moves along the guide rail. The rack is formed at the mold bottom, extends between its front and rear ends, and can engage with the drive gear. With the drive gear engaging with the rack of the mold at the starting point, the rotation of the gear in one direction gathers the molds end to end in the conveying path and conveys the gathered molds forward along the path.

While the molds are conveyed along the conveying path, their wheels run on the parallel rails, with their guides guided by the guide rail. The rotation of the drive gear drives the mold at the starting point of the conveying path so as to gather the molds end to end in the path and convey the gathered molds in the form of a train forward along the path.

It is preferable that a cooler be fitted rearward of the drawing mechanism. The cooler blows cooling air against the suction cupped sheet in the molds being conveyed forward along the conveying path. When the molded sheet is drawn from the molds, the cooling air cools the thermoplastic resin to reliably solidifies it.

The mold circulator may include a rear elevator fitted in the rear of the starting point of the conveying path and a front elevator fitted in front of the end point of the conveying path. Each of the elevators includes a platform, a piston cylinder, a piston rod and a magnet. The platform reciprocates vertically relative to the conveying path. The piston cylinder is fixed to the platform and reciprocates the piston rod in parallel with the conveying path. The magnet is fixed to the forward end of the piston rod and attracts the molds. The mold circulator may also include return rails and a return guide rail all extending under and along the conveying path. The circulator may also include a chain conveyor extending in parallel with the return rails. The chain conveyor includes a pin protruding for engaging with the molds.

The circulation of the molds makes it possible to produce a suction cupped sheet unlimited in length. The rear elevator lifts the molds at the starting point of the conveying path, and the front elevator lowers them at the end point of the path. Accordingly, the distance required for the mold circulation is shortened to a half or less, so that the space required for the installation of the apparatus is reduced. It is possible to reliably transfer the molds between the conveying path and each of the elevators by reciprocating the piston rods with the magnets, which can attract the molds.

The apparatus may further include two vertical racks fixed relative to the conveying path. Each of the elevators may further include a drive pinion supported by the associated platform. The drive pinion engages with one of the vertical racks.

Alternatively, the apparatus may further include two drive pinions each supported on a horizontal axis fixed relative to the conveying path. In this case, each of the elevators may further include a vertical rack fixed to the associated platform. The vertical rack engages with one of the drive pinions.

In either case, the rotation of each of the drive pinions vertically moves the associated platform. This makes it possible to lift and lower each of the elevators reliably in the minimum space.

The molder may be fixed to a base frame. The apparatus may further include an extruder rail, along which the extruder can move. The extruder rail is adjacent to the starting point of the conveying path, extends in parallel with the path and is fixed relative to the base frame.

The apparatus may further include a screw rod, which is supported rotatably by the base frame and extends in parallel with the conveying path. The extruder may further include a nut fixed to it.

Alternatively, the extruder may further include a screw rod supported rotatably by it and extending in parallel with the conveying path. In this case, the apparatus may further include a nut fixed to the base frame.

In either case, the nut engages with the screw rod, so that the rotation of the rod positions the extruder relative to the molder. Consequently, the movement of the extruder along the extruder rail makes it possible to finely adjust the position where the extruder starts to extrude resin into the molds.

The T-die may be divided into two parts for simple cleaning. The T-die has a resin passage formed through it and may include an obstacle, which can protrude orthogonally into the passage so as to control the extrusion of resin through the passage.

### BRIEF DESCRIPTION OF THE DRAWINGS

A preferred embodiment of the present invention is shown in the accompanying drawings, in which:

FIG. 1 is a schematic side view of an apparatus for producing a suction cupped sheet;

FIG. 2 is a schematic side view of part of the apparatus, showing how its mold conveyor conveys its molds;

FIG. 3 is a schematic side view of part of the apparatus, showing its front elevator etc.;

FIG. 4 is a perspective view of part of the apparatus, showing its forming roll, slitters, etc.;

FIG. 5 is a perspective view of part of the apparatus, showing how its drawing mechanism draws the suction cupped sheet from its molds;

FIG. 6 is a perspective view of part of the apparatus, showing how its molds transfer from its upper conveying path to its front elevator, and from the elevator to its lower conveying path;

FIG. 7 is an enlarged vertical section of part of a mold of the apparatus;

FIG. 8 is a vertical section of the apparatus, showing its conveying paths etc.;

FIG. 9 is an enlarged vertical section of the T-die of the apparatus;

FIG. 10 is a perspective view of part of the apparatus, showing how its molds are conveyed along the lower conveying path;

FIG. 11 is a front view of an upper part of the extruder of the apparatus;

FIG. 12 is a side view of a front part of the extruder.

### DETAILED DESCRIPTION OF THE PREFERRED EMBODIMENT

Structure

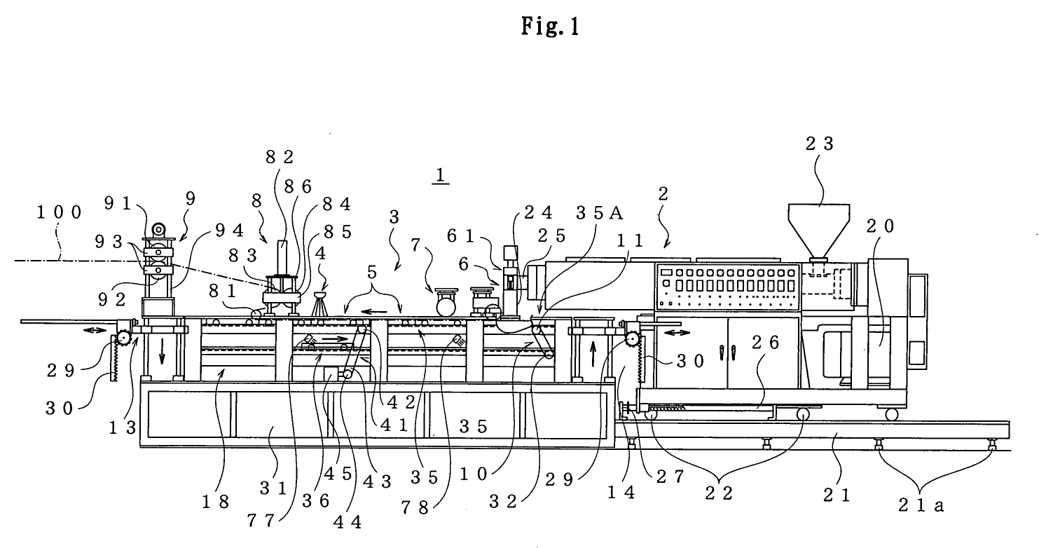

With reference to FIG. 1, an apparatus 1 for producing a suction cupped sheet comprises an extruder 2 and a suction cup molder 3. A pair of horizontal extruder rails 21 are supported over a floor by height adjusting bolts 21a. A long base frame 31 rests on the floor and extends in the same direction as the extruder rails 21.

The extruder 2 has wheels 22 fitted at its bottom, which run on the extruder rails 21, and a nut 27 fixed to its bottom. The base frame 31 supports a screw rod 26 extending in parallel with the extruder rails 21. The screw rod 26 engages with the extruder nut 27 and can be rotated by a motor (not shown) to move the extruder 2 along the extruder rails 21. The extruder 2 includes a T-die 24, which can be positioned finely by the rotation of the screw rod 26.

The cup molder 3 has an upper conveying path 35 and a lower conveying path 36 both extending along and over the base frame 31. The upper path 35 is positioned over the lower path 36. The cup molder 3 includes a front elevator 13 and a rear elevator 14 both fitted on the base frame 31. The front elevator 13 is located in front of the conveying paths 35 and 36. The rear elevator 14 is located in the rear of the conveying paths 35 and 36.

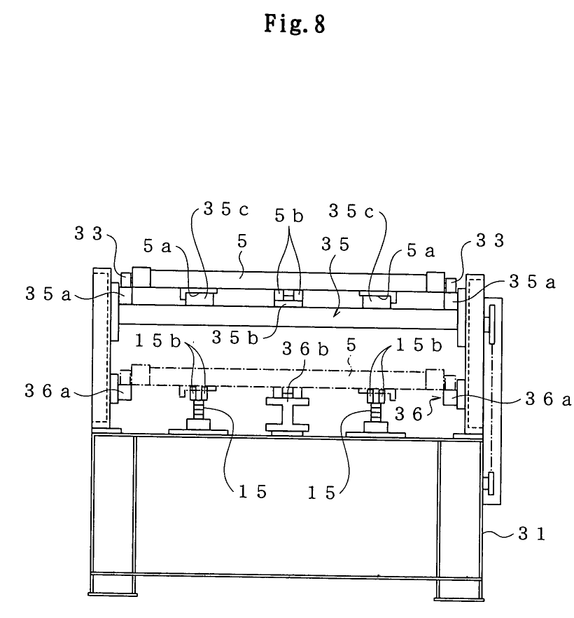

As shown in FIG. 8 etc., the upper conveying path 35 has a pair of side rails 35a extending along both its edges, a pair of guide rails 35c extending in parallel with and inside the side rails 35a, and a center rail 35b extending in parallel with and inside the guide rails 35c. Mold 5 has a pair of L-shaped guide frames 5a formed on its bottom. Each guide frame 35a has a bottom flange formed along its outer edge. The guide frames 5a extend along both sides of mold 5 and spaced from each other. Mold 5 also has side and center wheels 33. Mold 5 can move forward along the upper conveying path 35, with its guide frames 5a sliding along the guide rails 35c, and with its side and center wheels 33 running on the side and center rails 35a and 35b, respectively.

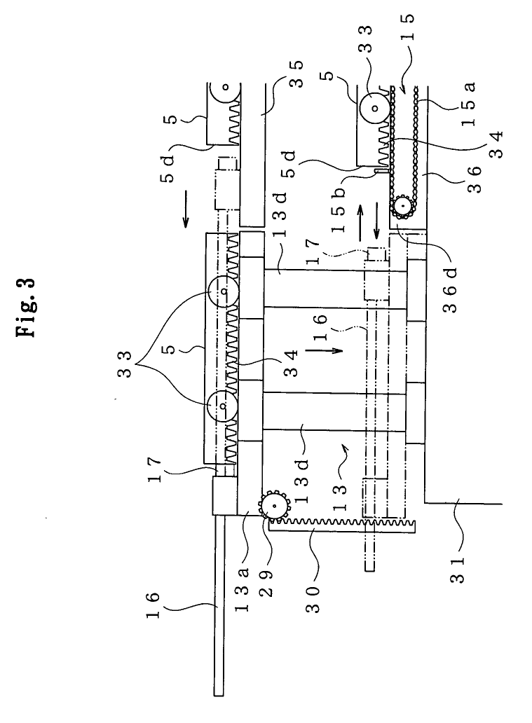

The lower conveying path 36 has a pair of side rails 36a extending along both its edges and a center rail 36b extending in parallel with and inside the side rails 36a. As shown in FIGS. 3, 6 and 8, the lower conveying path 36 also has a pair of chain conveyors 15 extending along both its edges. The chain conveyors 15 are spaced laterally from each other and slightly inward from both edges of the lower conveying path 36. Each chain conveyor 15 includes a pair of chains 15a and a number of pins 15b, which protrude from the chains 15a and are spaced at regular intervals along them. The chains 15 run clockwise in FIG. 3 to convey molds 5 along the lower conveying path 36, with pins 15b engaging with the rear end faces 5d of the molds.

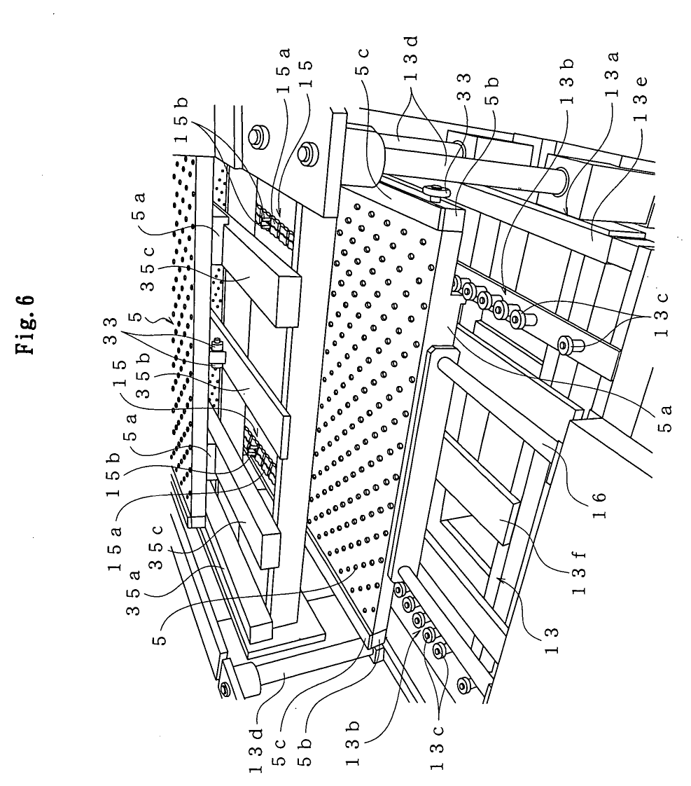

As shown in FIGS. 3 and 6, the front elevator 13 includes a platform 13a, a right pair of vertical guide shafts 13d and a left pair of vertical guide shafts 13d. Likewise, the rear elevator 14 includes a platform 14a, a right pair of vertical guide shafts 14d and a left pair of vertical guide shafts 14d. The platforms 13a and 14a can move vertically along the guide shafts 13d and 14d, respectively, which stand on the base frame 31. The platforms 13a and 14a are fitted with a pair of guide roller assemblies 13b and a pair of guide roller assemblies 14b, respectively, lying on their tops. The roller assemblies 13b and 14b include numbers of vertical guide rollers 13c and 14c, respectively, which are lined up in parallel with the various rails.

Mold 5 can transfer from the upper conveying path 35 to the platform 13a of the front elevator 13, where the bottom flanges of its guide frames 5a come into contact with the guide rollers 13c. Likewise, mold 5 can transfer from the lower conveying path 36 to the platform 14a of the rear elevator 14, where the bottom flanges of its guide frames 5a come into contact with the guide rollers 14c.

As shown in FIGS. 1 and 3, each of the platforms 13a and 14a supports a drive pinion 29 at its bottom and is fitted with a motor (not shown). The drive pinion 29 engages with a vertical rack 30, which may be fixed to the base frame 31. The motor rotates the drive pinion 29 to vertically move the platform 13a or 14a. Alternatively, the drive pinion 29 and the motor might be fitted to the base frame 31. In this case, the rack 30 might be fixed to the platform 13a or 14a.

As shown in FIGS. 1, 3 and 6, the front elevator platform 13a supports a pair of piston rods 16 on its front end. Likewise, the rear elevator platform 14a supports a pair of piston rods 16 on its rear end. The piston rods 16 can be reciprocated in parallel with the various rails by air cylinder mechanisms (not shown). Alternatively, the piston rods 16 might be formed with racks, each of which engages with a pinion. The pinion can be rotated by a motor. Each pair of piston rods 16 is fitted with a magnet 17 on their ends adjacent to the conveying paths 35 and 36. The magnet 17 attracts the adjacent end of mold 5.

With the front magnet 17 in contact with mold 5 at the end point of the upper conveying path 35, the retraction of the front elevator piston rods 16 transfers this mold from this path to the platform 13a.

As shown in FIG. 6, the platform 13a has a pair of side rails 13e and a center rail 13f all lying on its top in parallel with the other rails. Likewise, the platform 14a has a pair of side rails and a center rail (not shown) all lying on its top in parallel with the other rails. These rails support the wheels 33 of molds 5.

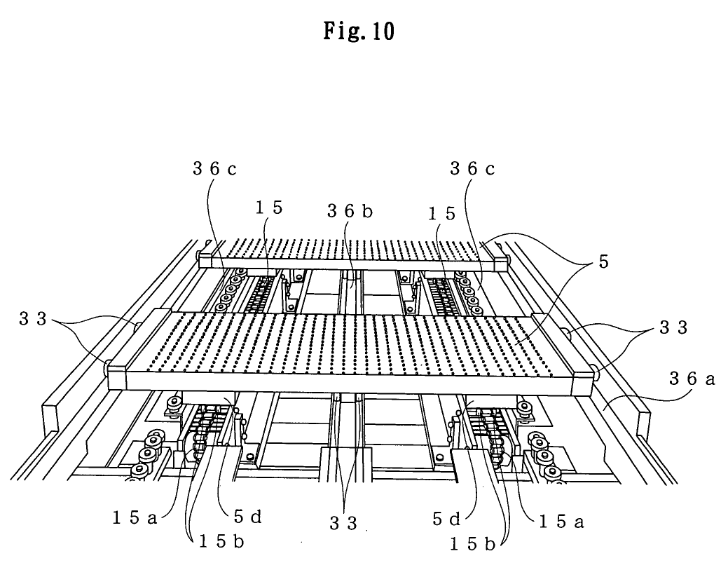

As shown in FIGS. 8 and 10, the lower conveying path 36 has a pair of side rails 36a, a center rail 36b and a pair of guide roller assemblies 36c all extending in parallel with the other rails.

The rotation of the drive pinion 29 of the front elevator 13 in one direction lowers the platform 13a together with mold 5 to the level of the lower conveying path 36. With the platform 13a at this height, the forward movement of the associated piston rods 16 transfers the mold 5 from this platform to the lower conveying path 36, where the mold wheels 33 can run on the rails 36a and 36b, while the mold guide frames 5a are guided by the roller assemblies 36c. Subsequently, pins 15b of the chain conveyors 15 come into contact with the rear end faces 5d of the transferred mold 5. At the same time, compressed air is injected near the magnet 17 of the front elevator 13 to separate the magnet from the mold 5. Subsequently, the piston rods 16 retract to their home positions. As shown in FIG. 10, the conveyor chains 15a run with pins 15b in contact with the mold 5 so as to convey the mold along the lower conveying path 36 to the position under the starting point of the upper conveying path 35. Subsequently, the mold 5 transfers from the lower conveying path 36 to the platform 14a of the rear elevator 14 like it transfers from the upper conveying path 35 to the front elevator platform 13a.

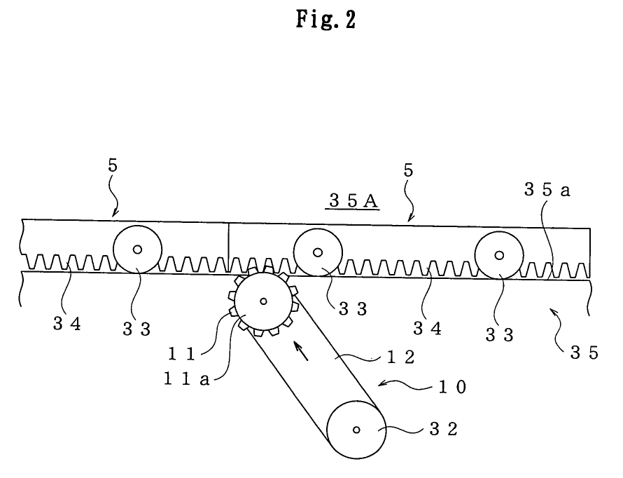

As shown in FIGS. 2 and 3, mold 5 has a pair of bottom racks 34 formed on both its sides. As shown in FIGS. 1 and 2, the cup molder 3 is fitted with a mold conveyor 10 under the standby position 35A at the starting point of the upper conveying path 35. The mold conveyor 10 includes a pair of drive pinions 11, a driven pulley 11a, a drive belt 12, a drive pulley 32 and a motor (not shown). The drive belt 12 connects the two pulleys 11a and 32. The drive pinions 11 are fixed to the driven pulley 11a. The drive pinions 11 and driven pulley 11a are so supported that they can move toward and away from the mold 5 at the standby position 35A. While the producing apparatus 1 is operating, the drive pinions 11 rotate counterclockwise in FIGS. 1 and 2 at a constant speed. With the drive pinions 11 engaging with the bottom racks 34 of the mold 5, the rotation of these pinions moves it forward.

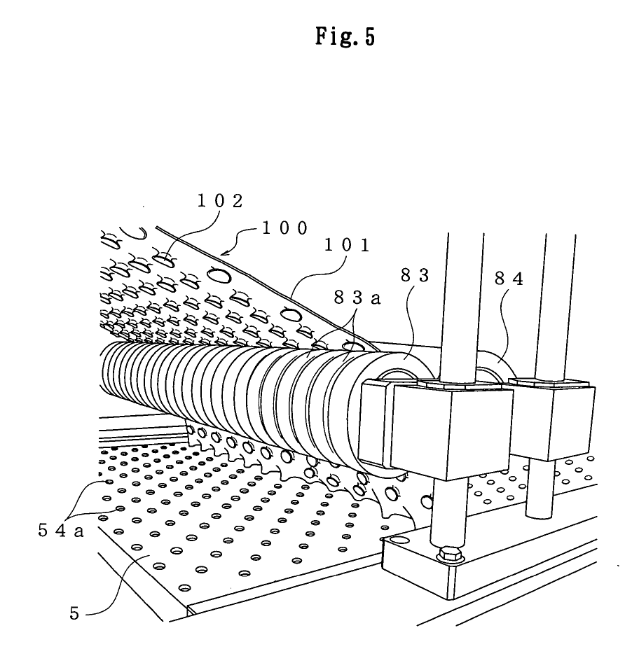

The cup molder 3 is fitted with a braking device 41 in the rear of and below a cooler 4, which is located in the rear of a drawing mechanism 8 and over the upper conveying path 35. The drawing mechanism 8 is located near the end point of the upper conveying path 35. The braking device 41 includes a pair of pinions 42, an endless belt 43, a horizontal shaft 44 and a presser 45. Each pinion 42 can engage with one bottom rack 34 of mold 5. The pinions 42 are fixed together by a horizontal shaft (not shown), which is connected with the horizontal shaft 44 by the endless belt 43. The presser 45 presses a brake pad (not shown) against the horizontal shaft 44 to brake the pinions 42. This brakes the mold 5 moving forward five or six molds ahead of the mold driven by the drive pinions 11 of the mold conveyor 10. Consequently, the molds 5 between the mold conveyor 10 and braking device 41 are gathered in an end-to-end fashion. As a result, the pitch of suction cups 102 (FIG. 5) of suction cupped sheet 100 is kept constant, so that the sheet is an accurate product.

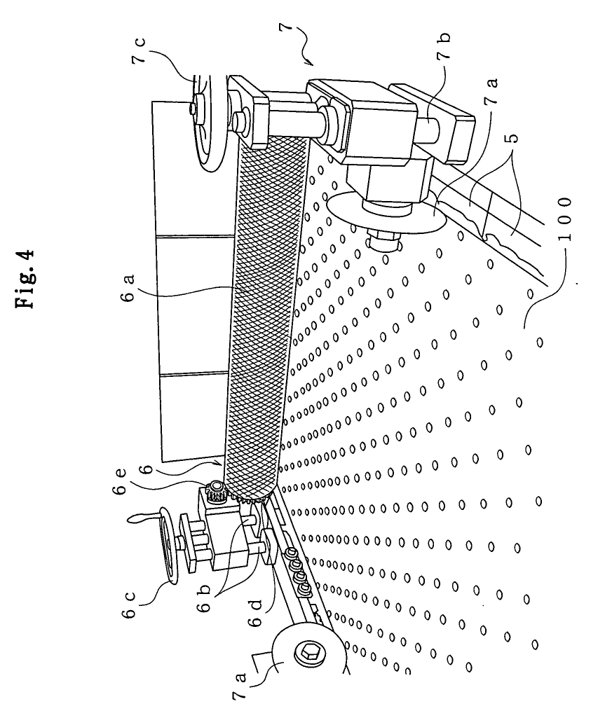

As shown in FIGS. 4 and 5, the suction cupped sheet 100 includes a base sheet 101 and an array of suction cups 102 formed on its one side integrally with it. The suction cupped sheet 100 may be 90 cm in width. The suction cups 102 may have a diameter of 12 mm and be arranged at intervals of about 26 mm longitudinally and laterally of the suction cupped sheet 100. Alternatively, the suction cups 102 may have a diameter of 24 mm and be arranged at intervals of about 75 mm longitudinally and laterally of the suction cupped sheet 100. It is possible to vary the diameter and intervals of the suction cups 102 for different purposes by replacing the molds 5. The suction cupped sheet 100 is made of a thermoplastic soft resin, such as an olefin series thermoplastic elastomer, a styrene series thermoplastic elastomer or a vinyl chloride series thermoplastic elastomer, depending on the purpose.

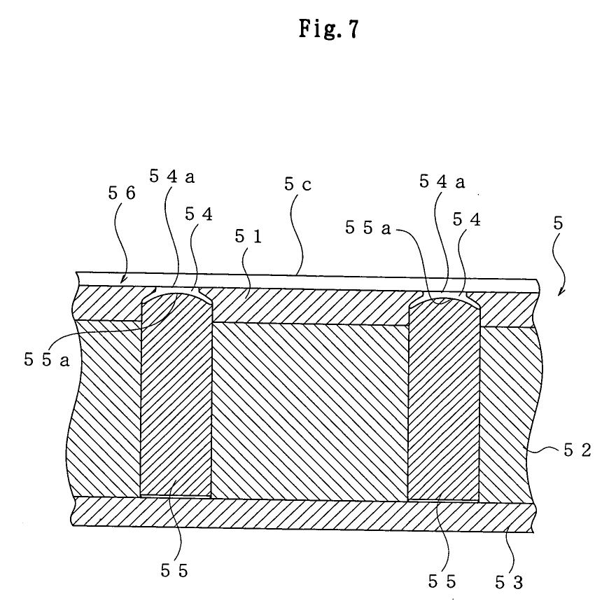

The molds 5 are ten in number, seven of which are used for the sheet molding process at a time. The other three molds 5 are circulating to the standby position 35A. One mold 5 may be lowered by the front elevator 13. Another mold 5 may be returning along the lower conveying path 36. Still another mold 5 may be lifted by the rear elevator 14. The molds 5 are slightly wider than the suction cupped sheet 100. As shown in FIG. 7, mold 5 has a number of circular molding cavities 54 formed in its flat top side for the molding of suction cups 102. The open top 54a of each molding cavity 54 is narrowed so as to form the neck 102b of suction cup 102.

For example, when six molds 5 are gathered in an end-to-end fashion in the upper conveying path 35, with one of them in the standby position 35A, the piston rods 16 of the rear elevator 14 push another mold 5 from the associated platform 14a into the standby position 35A. As a result, a train of seven molds 5 is formed in the upper conveying path 35. Subsequently, the piston rods 16 retract, and the drive pinions 11 of the mold conveyor 10 that are rotating at the constant speed engage with the bottom racks 34 of the mold 5 in the standby position 35A. This makes the train of seven molds 5 move forward along the upper conveying path 35.

When mold 5 has approached the end point of the upper conveying path 35, as shown in FIG. 3, the platform 13a of the front elevator 13 stands by at the level of this path. The associated piston rods 16 move forward from the platform 13a at this height into the upper conveying path 35, where the associated magnet 17 attracts the adjacent end face 5d of the mold 5. Subsequently, the piston rods 16 retract to transfer the mold 5 from the upper conveying path 35 to the platform 13a. When the mold 5 is positioned completely on the platform 13a, the drive pinion 29 supported by this platform is rotated. This lowers the platform 13a together with the mold 5 along the associated vertical rack 30 to the level of the lower conveying path 36. Subsequently, the piston rods 16 move forward to transfer the mold 5 from the platform 13a to the lower conveying path 36. When the mold 5 is positioned completely in the lower conveying path 36, pins 15b of the chain conveyors 15 engage with the rear end face 5d of the mold 5. The chains 15a of the chain conveyors 15 return the mold 5 to a position roughly under the starting point of the upper conveying path 35.

The returned mold 5 is transferred from the lower conveying path 36 to the platform 14a of the rear elevator 14, which lifts it. These operations are so controlled by a computer that the ten molds 5 circulate in the cup molder 3 counterclockwise in FIG. 1. The front elevator 13, chain conveyors 15 and rear elevator 14 form parts of a mold circulator 18.

Mold 5 is rectangular in horizontal section and open at its top. As shown in FIG. 7, mold 5 includes a top plate 51, a bottom plate 53 and an intermediate plate 52, which lies between the top and bottom plates. The three plates 51-53 are fixed together by bolts (not shown) extending upward from the bottom plate 53. As shown in FIG. 6, mold 5 includes a pair of side frames 5b, which support wheels 33 near their front and rear ends and are formed with racks 34 in their bottoms. Molding cavities 54 are formed in the top plate 51. Mold 5 further includes roughly columnar plugs 55 extending through its intermediate plate 52 and in its top plate 51. Each columnar plug 55 has a spherical top 55a, which defines the bottom of one molding cavity 54. The top plate 51 defines the bottom of a molding space 56 for the base sheet 101 of suction cupped sheet 100. Mold 5 further includes a pair of molding frames 5c each extending along and fixed to the top of one side frame 5b. The molding frames 5c define both sides of the molding space 56. The thickness of the molding frames 5c determine the thickness of the base sheet 101.

With reference to FIG. 1, the extruder 2 is fitted with a hopper 23 near the rear end of its top and formed with an outlet port 25 at its front end. The extruder 2 has a horizontal screw shaft (not shown), which can be rotated by an inverter motor 20. A thermoplastic soft resin is supplied from the hopper 23. While the rotating screw shaft is kneading the supplied resin, it forces the resin into the outlet port 25.

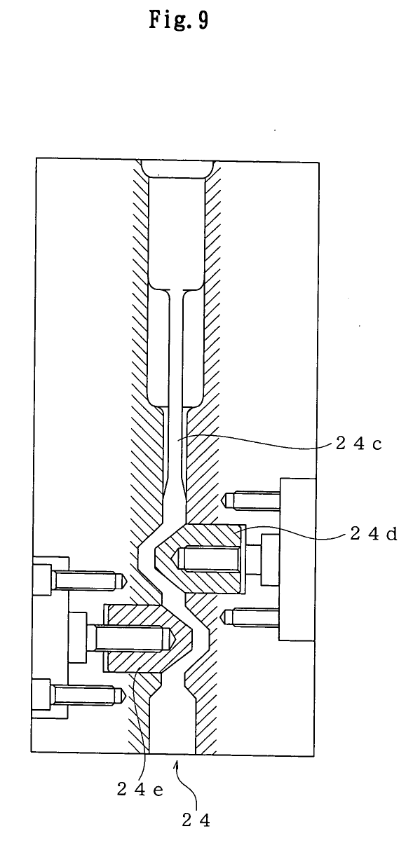

The T-die 24 is connected with the outlet port 25, faces downward and has a laterally large extruding port. The T-die 24 extrudes elastomer in the form of a sheet slightly wider than 900 mm from its extruding port into the mold 5 at the starting point of the upper conveying path 35. As shown in FIG. 9, the T-die 24 is divided vertically into two parts and has a generally vertical resin passage 24c, an upper set of obstacles 24d and a lower set of obstacles 24e. Each set of obstacles 24d or 24e is spaced vertically from the other. The sets of obstacles 24d and 24e can slide horizontally and protrude orthogonally into the resin passage 24c in opposite directions. The gap between the two parts of the T-die 24 can be adjusted by bolts to vary the amount of resin extruded from the die.

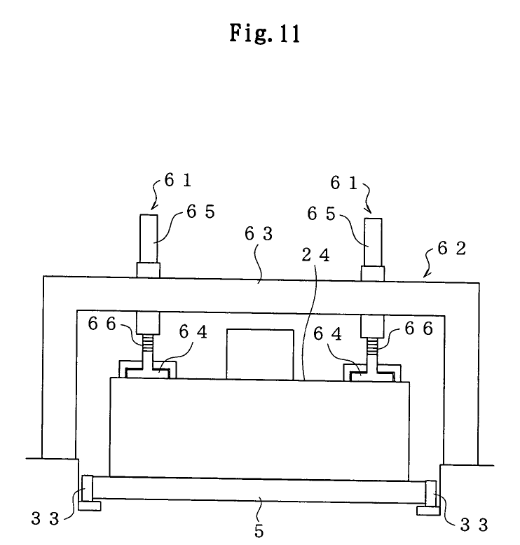

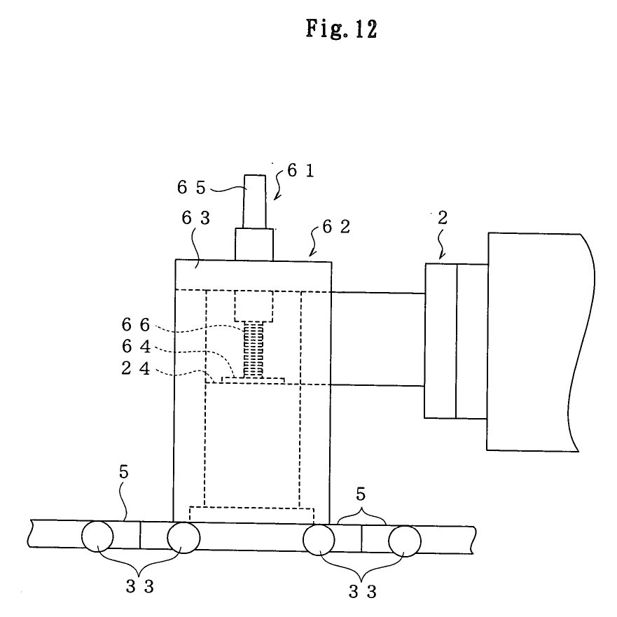

As shown in FIGS. 11 and 12, the T-die 24 and upper conveying path 35 are straddled by a gantry 62, which includes a horizontal top plate 63. The top plate 63 supports a pair of pressers 61 on both its sides. Each presser 61 has a motor 65, a screw shaft 66 and a press disc or plate 64. The motor 65 rotates the screw shaft 66 to vertically move the press disc 64, which can come into contact with the top of the T-die 24 to prevent this die from floating. The suction cups 102 of the suction cupped sheet 100 are molded in the molding cavities 54, while the base sheet 101 is molded on the tops of the molds 5. The amount of elastomer filling the molding cavities 54 is smaller than the amount of elastomer extruded by the T-die 24. Accordingly, the force of repulsion of the extruded elastomer is so great that the T-die 24 tends to float. This makes the pressers 61 necessary. The vertical positions of the press discs 64 and their positions where they come into contact with the top of the T-die 24 can be controlled suitably according to the size, sort, etc. of the suction cupped sheet 100.

The extruding port of the T-die 24 is positioned just in front of the standby position 35A in the upper conveying path 35. As shown in FIG. 1, the position of the extruding port can be adjusted finely by the rotation of the screw rod 26, which moves the extruder 2 on the rails 21. The gap between the extruding port and the top plate 51 of mold 5 equals the thickness of the molding frames 5c of mold 5 and determines the thickness of the base sheet 101 of the suction cupped sheet 100. It is possible to adjust this thickness generally between 1 and 5 mm by displacing the extruder 2 vertically relative to the cup molder 3. The displacement may involve rotating the adjusting bolts 21a, which support the rails 21.

With reference to FIGS. 1 and 4, forming roll equipment 6 includes a horizontal forming roll 6a supported rotatably just in front of the T-die 24 and extending over the full width of mold 5. The forming roll 6a can be displaced vertically along a right pair of vertical supports 6b and a left pair of vertical supports 6b so as to be positioned vertically according to the thickness of the base sheet 101 by two height adjusters 6c, which are fitted on both sides of the upper conveying path 35. A driven gear 6d is fixed to one end of the forming roll 6a and engages with a drive gear 6e. The counterclockwise rotation of the drive gear 6e in FIG. 1 rotates the forming roll 6a clockwise in FIG. 1 to feed the suction cupped sheet 100 forward. The rotational speed of the forming roll 6a is roughly equivalent to the speed at which the molds 5 are conveyed. The forming roll 6a rotates in contact with the back side of the resin sheet 101 extruded onto molds 5 and cools the sheet, which has a high temperature of about 200 degrees centigrade just after it is extruded.

The cylindrical surface of the forming roll 6a is flat, but might be wavy so as to print the back side of the resin sheet 101 with a wavy or drawing pattern, which is effective for slip resistance.

A temperature controller (not shown) is fitted near the standby position 35A in the upper conveying path 35. The temperature controller heats mold 5 with hot air or otherwise so as to reduce the temperature difference between the mold and the hot resin extruded from the T-die 24. This enables the extruded soft resin to flow smoothly into the molding cavities 54.

With reference to FIGS. 1 and 4, a pair of slitters 7 is mounted in front of the roll equipment 6 on both sides of the upper conveying path 35. Each slitter 7 includes a rotary knife 7a supported at a distance of 900 mm from the knife of the other slitter. While the molds 5 are conveyed, the rotary knives 7a rotate, cutting away the parts of the extruded and almost solidified sheet 101 that protrude on both its sides. As a result, the base sheet 101 is cut into a sheet having a width of 900 mm. Each rotary knife 7a is supported by a pair of vertical guide shafts 7b and can be positioned vertically according to the thickness of the base sheet 101 by a height adjuster 7c.

With reference to FIGS. 1 and 5, a drawing mechanism 8 is mounted backward of the end point of the upper conveying path 35 and includes a lower horizontal roller 81, an air cylinder 82, a pair of horizontal drawing rollers 83 and 84, a pair of roller supports 85, a right pair of vertical guide shafts 86 and a left pair of vertical guide shafts 86. The rollers 81 and 83 have numbers of annular grooves 81a and 83a, respectively, formed in their cylindrical surfaces so that they cannot interfere with the suction cups 102 while the base sheet 101 moves in contact with the cylindrical surfaces. The roller supports 85 support the ends of the drawing rollers 83 and 84 and can be slid vertically along the guide shafts 86 by the air cylinder 82. The air cylinder 82 quickly lifts the drawing rollers 83 and 84 to pull the suction cupped sheet 100 upward and backward through the lower roller 81, thereby drawing the molded suction cups 102 from the narrow tops 54a of molding cavities 54. The air cylinder 82 lowers the lifted rollers 83 and 84. In this way, the drawing mechanism 8 repeats the vertical movement of the drawing rollers 83 and 84.

If the suction cups 102 could be drawn smoothly from the molds 5, the movable rollers 83 and 84 might be held at a predetermined height without being vertically moved.

With reference to FIG. 1, a take-up mechanism 9 is mounted near the end point of the cup molder 3 and includes an upper horizontal take-up roller 91, a lower horizontal take-up roller 92, roller supports 93 and vertical guide shafts 94. The roller supports 93 support the take-up rollers 91 and 92 and can be positioned vertically along the guide shafts 94. The take-up rollers 91 and 92 are positioned forward of and above the drawing rollers 83 and 84 and take up the suction cupped sheet 100 from them. The lower take-up roller 92 has annular grooves 92a formed in its cylindrical surface so that it cannot interfere with the suction cups 102.

A cooler 4 is fitted in the rear of the drawing mechanism 8 and blows cooling air against the suction cupped sheet 100 in mold 5 to cool the sheet to a roughly normal temperature. The cooled sheet 100, inclusive of the suction cups 102, is solidified almost completely.

Two coolers 77 and 78 are fitted midway between both ends of the lower conveying path 36 and spaced from each other along the path. These coolers 77 and 78 blow cooling air against the molds 5 returning along the lower conveying path 36. The blown air cools the molds 5, inclusive of their wheels 33.

Operation

As shown in FIG. 1, the apparatus 1 has ten molds 5, and its operation is controlled automatically by the computer, with sensors fitted to it each for detecting whether there is a mold 5. Seven at a time of the ten molds 5 move in the form of a train along the upper conveying path 35. The other three molds 5 are located in any of the front elevator 13, lower conveying path 36 and rear elevator 14.

The rear elevator 14 lifts mold 5, which is then pushed by the associated piston rods 16 to transfer to the standby position 35A in the upper conveying path 35. As shown in FIG. 2, the drive pinions 11 of the mold conveyor 10 engage with the racks 34 of the mold 5 in the standby position 35A, where the mold 5 is heated to a suitable temperature by the hot air from the temperature controller (not shown). The drive pinions 11 move the mold 5, with its wheels 33 running on the rails 35a and 35b, and with its guide frames 5a sliding on the guide rails 35c.

Mold 5 moves from the standby position 35A to the position just under the T-die 24, which extrudes a soft resin in the form of a sheet, forcing it into the molding space 56 and molding cavities 54 of the mold. With reference to FIG. 4, the forming roll 6a, which is supported just in front of the T-die 24, presses and cools the base sheet 101 in the molding space 56. The forming roll 6a is positioned vertically in advance according to the thickness of the base sheet 101 by the height adjusters 6c.

With reference to FIG. 4, when mold 5 reaches the slitters 7, their rotary knives 7a cut the pressed and cooled sheet 101 into a sheet that is 900 mm wide. While molds 5 are conveyed forward in the form of a train along the upper conveying path 35, the extruded resin gradually solidifies. The nozzles of the cooler 4, which is fitted in front of the drawing mechanism 8, blow air for cooling the suction cupped sheet 100 to solidify it, thereby completing the molding process.

With reference to FIG. 5, when mold 5 reaches the drawing mechanism 8, the air cylinder 82 lifts the drawing rollers 83 and 84 to pull the solidified sheet 100 upward and backward through the lower roller 81. This draws the molded suction cups 102 from the cavity tops 54a of the mold 5, thereby releasing the solidified sheet 100 from the mold 5. The suction cups 102, which may be 12 or 24 mm in outer diameter, are quite larger than the cavity tops 54a, which may be 7.6 or 16 mm in diameter. However, because the suction cupped sheet 100 is made of elastomer, which is elastic, the suction cups 102 can be drawn easily from the cavity tops 54a.

With reference to FIG. 1, while the empty mold 5 is conveyed forward, the drawn sheet 100 is guided and pulled forward by the take-up rollers 91 and 92, which are downstream of the drawing mechanism 8. The guided and pulled sheet 100 is wound up by a wind-up roll (not shown).

With reference to FIG. 3, when the empty mold 5 reaches the end point of the upper conveying path 35, it is sensed by a sensor (not shown), so that the piston rods 16 of the front elevator 13 move forward from the platform 13a standing by at its top position. The piston rods 16 move until the associated magnet 17 comes into contact with the mold 5. Subsequently, the piston rods 16 retract to transfer the mold 5 to the platform 13a. With reference to FIG. 6, the mold 5 transfers accurately to the predetermined position on the platform 13a, with its guide frames 5a guided by the upright guide rollers 13c. When the mold 5 has completely transferred to the platform 13a, it is sensed by a sensor (not shown), so that the drive pinion 29 of this platform is rotated to lower the platform along the associated rack 30.

When the lowered mold 5 reaches the level of the lower conveying path 36, it is sensed by a sensor (not shown), so that the piston rods 16 move forward to transfer the mold 5 from the platform 13a to this path. When the mold 5 has transferred to the lower conveying path 36, as shown in FIG. 3, pins 15b of the chain conveyors 15 engage with the mold 5 so that the mold can be conveyed along this path. In the meantime, the magnet 17 leaves the mold 5, and the piston rods 16 retract. Then, the platform 13a is lifted to the level of the upper conveying path 35.

The chain conveyors 15 convey the mold 5 along the lower conveying path 36 to the position just under the starting point of the upper conveying path 35. Subsequently, the mold 5 is transferred from this position to the platform 14a of the rear elevator 14 by the reciprocation of the associated piston rods 16 like it is transferred to the platform 13a. Subsequently, the platform 14a is lifted to the level of the upper conveying path 35. The piston rods 16 move forward from the lifted elevator 14a to transfer the mold 5 from this elevator to the standby position 35A in the upper conveying path 35, thereby completing the circulating process.

Modifications

The number of molds 5 for use in the molding process is calculated from the time required for the solidification of the soft resin extruded from the extruder 3 into the molds. The number of molds 5 for use in this process might not be limited to seven, but vary according to the resin type and/or the sheet size. Alternatively, with the number of molds 5 unchanged, the rotational speed of the drive pinions 11 of the mold conveyor 10 might vary.

The cylindrical surface of the forming roll 6a might have a wavy or drawing pattern so as to print the back side of the resin sheet 101 with this pattern for slip resistance.

The producing apparatus 1 might include two or more extruders 3, one of which could extrude a sheet of resin onto the sheet of resin extruded from another. The thus laminated base sheet 101 would be thick. If the materials for the extruded sheets are different, the light resistance of the base sheet 101 would be improved. The two or more extruders 3 would make it possible to mix a reflecting agent with the base sheet 101. The extruders 3 would also make it possible to mold base sheets 101 with different properties for various purposes. The extruders 3 would further make it possible to mix a coloring agent (master batch) with the resin so as to color suction cupped sheets 100 optionally for various purposes.

Advantages

The producing process according to the present invention is based on the combination of the extrusion of resin and a continuous flow of the extruded resin. The continuous flow is created by the circulation of molds. This process implements a mass production system, which can produce a wide suction cupped sheet unlimited in length at a high speed and a low cost in comparison with the conventional (mainly injection molding) process.

The producing apparatus according to the present invention can reliably perform the producing process. The producing apparatus has a plurality of molds in a regular shape and continuously molds a suction cupped sheet by circulating them. This makes the mold production cost relatively low. The suction cupped sheet is molded while the molds are conveyed in the form of a train. The molded sheet is drawn from the molds in the direction opposite to the direction in which they are conveyed. The molded sheet may be drawn upward from the molds. Consequently, the suction cups of the molded sheet are drawn from the mold cavities by taking advantage of its elastomeric property. This makes it possible to draw the suction cupped sheet reliably and efficiently from the molds.

The producing apparatus circulates each mold by conveying it linearly along an upper conveying path, lowering it from the end point of this path by means of an elevator, returning the lowered mold linearly along a lower conveying path and lifting it from the end point of this path to the starting point of the upper conveying path by means of another elevator. Accordingly, the producing apparatus can be compact and installed in a small space.

1. A process for continuously producing a suction cupped sheet of a predetermined width with a number of suction cups on a resin sheet by means of an apparatus having an endless track including an upper horizontal linear conveying path and a lower horizontal linear conveying path, wherein the starting and end points of the upper conveying path are positioned over the end and starting points respectively of the lower conveying path, the apparatus including a plurality of molds movable along the track, the process comprising the steps of:
extruding a thermoplastic soft resin in the form of a sheet sequentially into the molds being conveyed in the form of a train forward near the starting point of the upper conveying path;
molding the extruded resin into a suction cupped sheet by conveying the molds forward along the upper conveying path until the extruded resin is solidified;
drawing the suction cupped sheet sequentially from the molds near the end point of the upper conveying path to empty the molds;
lowering the emptied molds sequentially from the end point of the upper conveying path to the starting point of the lower conveying path;
returning the lowered molds from the starting point of the lower conveying path to the end point of the lower conveying path; and
lifting the returned molds sequentially from to the end point of the lower conveying path to the starting point of the upper conveying path.

2. A process for continuously producing a suction cupped sheet of a predetermined width with a number of suction cups on a resin sheet by means of an apparatus having an endless track including an upper horizontal linear conveying path and a lower horizontal linear conveying path, wherein the starting and end points of the upper conveying path are positioned over the end and starting points respectively of the lower conveying path, the apparatus including a plurality of molds movable along the track, the process comprising the steps of:
extruding different kinds of thermoplastic soft resin in the form of sheets sequentially into the molds to form a laminated sheet in the molds being conveyed in the form of a train forward through different points near the starting point of the upper conveying path;
molding the laminated sheet into a suction cupped sheet by conveying the molds forward along the upper conveying path until the laminated sheet is solidified;
drawing the suction cupped sheet sequentially from the molds near the end point of the upper conveying path to empty the molds;
lowering the emptied molds sequentially from the end point of the upper conveying path to the starting point of the lower conveying path;
returning the lowered molds from the starting point of the lower conveying path to the end point of the lower conveying path; and
lifting the returned molds sequentially from to the end point of the lower conveying path to the starting point of the upper conveying path.

3. An apparatus for continuously producing a suction cupped sheet of a predetermined width with a number of suction cups on a resin sheet, the apparatus comprising:
a plurality of molds;
a molder having an endless track including a horizontal linear conveying path;
the molder including a mold conveyor for conveying the molds in the form of a train forward along the conveying path;
an extruder including a T-die for extruding a thermoplastic soft resin sequentially into the molds being conveyed along the conveying path, the T-die facing downward and fitted over the conveying path near the starting point of the path;
the molder adapted to mold the extruded resin into a suction cupped sheet by conveying the molds along the conveying path until the extruded resin is solidified;
a forming roll supported near and forward of the extruder for forming the top of the extruded resin into a continuous surface and cooling the resin;
a drawing mechanism fitted near the end point of the conveying path for drawing the suction cupped sheet sequentially from the molds upward and backward to empty the molds while the molds are conveyed along the conveying path; and
a mold circulator for circulating the emptied molds to the starting point of the conveying path.

4. An apparatus according to claim 3, and further comprising a temperature controller fitted near the starting point of the conveying path for heating the molds.

5. An apparatus according to claim 3, wherein the mold conveyor comprises a plurality of parallel rails extending along the conveying path, a guide rail extending in parallel with the parallel rails, and a drive gear supported near the starting point of the conveying path;
the molds each including wheels supported at least on both sides of the bottom thereof for running on the parallel rails, a guide fixed to the bottom thereof and extending between the front and rear ends thereof for moving along the guide rail, and a rack formed at the bottom thereof and extending between the front and rear ends thereof for engaging with the drive gear;
and wherein, with the drive gear engaging with the rack of the mold at the starting point, the rotation of the gear in one direction gathers the molds end to end in the conveying path and conveys the gathered molds forward along the path.

6. An apparatus according to claim 3, and further comprising a cooler fitted rearward of the drawing mechanism for blowing cooling air against the suction cupped sheet in the molds being conveyed forward.

7. An apparatus according to claim 3, wherein the mold circulator comprises:
a rear elevator fitted in the rear of the starting point of the conveying path;
a front elevator fitted in front of the end point of the conveying path;
the elevators each including a platform for reciprocating vertically relative to the conveying path, a piston rod, a piston cylinder fixed to the platform for reciprocating the rod in parallel with the conveying path, and a magnet fixed to the forward end of the rod for attracting the molds;
a plurality of return rails extending under and along the conveying path;
a return guide rail extending in parallel with the return rails; and
a chain conveyor extending in parallel with the return rails;
the chain conveyor including a pin protruding for engaging with the molds.

8. An apparatus according to claim 7, and further comprising:
two vertical racks fixed relative to the conveying path;
the elevators each further including a drive pinion supported by the associated platform, the pinion engaging with one of the vertical racks;
wherein the rotation of the drive pinion vertically moves the associated platform.

9. An apparatus according to claim 7, and further comprising:
two drive pinions each supported on a horizontal axis fixed relative to the conveying path;
the elevators each further including a vertical rack fixed to the associated platform, the rack engaging with one of the drive pinions;
wherein the rotation of each of the drive pinions vertically moves the associated platform.

10. An apparatus according to claim 3, and further comprising:
a base frame to which the molder is fixed;
an extruder rail adjacent to the starting point of the conveying path;
the extruder rail extending in parallel with the conveying path and fixed relative to the base frame;
the extruder being movable along the extruder rail; and
a screw rod supported rotatably by the base frame and extending in parallel with the conveying path;
the extruder including a nut fixed thereto and engaging with the screw rod, so that the rotation of the rod positions the extruder relative to the molder.

11. An apparatus according to claim 3, and further comprising:
a base frame to which the molder is fixed;
an extruder rail adjacent to the starting point of the path;
the extruder rail extending in parallel with the conveying path and fixed relative to the base frame;
the extruder being movable along the extruder rail;
the extruder further including a screw rod supported rotatably thereby and extending in parallel with the conveying path; and
a nut fixed to the base frame and engaging with the screw rod, so that the rotation of the rod positions the extruder relative to the molder.

12. An apparatus according to claim 3, wherein the T-die is divided into two parts.

13. An apparatus according to claim 3, wherein the T-die has a resin passage formed therethrough and includes an obstacle orthogonally protrudable into the passage.

14. An apparatus according to claim 4, wherein the mold conveyor comprises a plurality of parallel rails extending along the conveying path, a guide rail extending in parallel with the parallel rails, and a drive gear supported near the starting point of the conveying path;
the molds each including wheels supported at least on both sides of the bottom thereof for running on the parallel rails, a guide fixed to the bottom thereof and extending between the front and rear ends thereof for moving along the guide rail, and a rack formed at the bottom thereof and extending between the front and rear ends thereof for engaging with the drive gear;
and wherein, with the drive gear engaging with the rack of the mold at the starting point, the rotation of the gear in one direction gathers the molds end to end in the conveying path and conveys the gathered molds forward along the path.

15. An apparatus according to claim 4, and further comprising a cooler fitted rearward of the drawing mechanism for blowing cooling air against the suction cupped sheet in the molds being conveyed forward.

16. An apparatus according to claim 5, and further comprising a cooler fitted rearward of the drawing mechanism for blowing cooling air against the suction cupped sheet in the molds being conveyed forward.

17. An apparatus according to claim 4, wherein the mold circulator comprises:
a rear elevator fitted in the rear of the starting point of the conveying path;
a front elevator fitted in front of the end point of the conveying path;
the elevators each including a platform for reciprocating vertically relative to the conveying path, a piston rod, a piston cylinder fixed to the platform for reciprocating the rod in parallel with the conveying path, and a magnet fixed to the forward end of the rod for attracting the molds;
a plurality of return rails extending under and along the conveying path;
a return guide rail extending in parallel with the return rails; and
a chain conveyor extending in parallel with the return rails;
the chain conveyor including a pin protruding for engaging with the molds.

18. An apparatus according to claim 5, wherein the mold circulator comprises:
a rear elevator fitted in the rear of the starting point of the conveying path;
a front elevator fitted in front of the end point of the conveying path;
the elevators each including a platform for reciprocating vertically relative to the conveying path, a piston rod, a piston cylinder fixed to the platform for reciprocating the rod in parallel with the conveying path, and a magnet fixed to the forward end of the rod for attracting the molds;
a plurality of return rails extending under and along the conveying path;
a return guide rail extending in parallel with the return rails; and
a chain conveyor extending in parallel with the return rails;
the chain conveyor including a pin protruding for engaging with the molds.

19. An apparatus according to claim 6, wherein the mold circulator comprises:
a rear elevator fitted in the rear of the starting point of the conveying path;
a front elevator fitted in front of the end point of the conveying path;
the elevators each including a platform for reciprocating vertically relative to the conveying path, a piston rod, a piston cylinder fixed to the platform for reciprocating the rod in parallel with the conveying path, and a magnet fixed to the forward end of the rod for attracting the molds;
a plurality of return rails extending under and along the conveying path;
a return guide rail extending in parallel with the return rails; and
a chain conveyor extending in parallel with the return rails;
the chain conveyor including a pin protruding for engaging with the molds.

20. An apparatus according to claim 4, and further comprising:
a base frame to which the molder is fixed;
an extruder rail adjacent to the starting point of the conveying path;
the extruder rail extending in parallel with the conveying path and fixed relative to the base frame;
the extruder being movable along the extruder rail; and
a screw rod supported rotatably by the base frame and extending in parallel with the conveying path;
the extruder including a nut fixed thereto and engaging with the screw rod, so that the rotation of the rod positions the extruder relative to the molder.

21. An apparatus according to claim 5, and further comprising:
a base frame to which the molder is fixed;
an extruder rail adjacent to the starting point of the conveying path;
the extruder rail extending in parallel with the conveying path and fixed relative to the base frame;
the extruder being movable along the extruder rail; and
a screw rod supported rotatably by the base frame and extending in parallel with the conveying path;
the extruder including a nut fixed thereto and engaging with the screw rod, so that the rotation of the rod positions the extruder relative to the molder.

22. An apparatus according to claim 6, and further comprising:
a base frame to which the molder is fixed;
an extruder rail adjacent to the starting point of the conveying path;
the extruder rail extending in parallel with the conveying path and fixed relative to the base frame;
the extruder being movable along the extruder rail; and
a screw rod supported rotatably by the base frame and extending in parallel with the conveying path;
the extruder including a nut fixed thereto and engaging with the screw rod, so that the rotation of the rod positions the extruder relative to the molder.

23. An apparatus according to claim 7, and further comprising:
a base frame to which the molder is fixed;
an extruder rail adjacent to the starting point of the conveying path;
the extruder rail extending in parallel with the conveying path and fixed relative to the base frame;
the extruder being movable along the extruder rail; and
a screw rod supported rotatably by the base frame and extending in parallel with the conveying path;
the extruder including a nut fixed thereto and engaging with the screw rod, so that the rotation of the rod positions the extruder relative to the molder.

24. An apparatus according to claim 8, and further comprising:
a base frame to which the molder is fixed;
an extruder rail adjacent to the starting point of the conveying path;
the extruder rail extending in parallel with the conveying path and fixed relative to the base frame;
the extruder being movable along the extruder rail; and
a screw rod supported rotatably by the base frame and extending in parallel with the conveying path;
the extruder including a nut fixed thereto and engaging with the screw rod, so that the rotation of the rod positions the extruder relative to the molder.

25. An apparatus according to claim 9, and further comprising:
a base frame to which the molder is fixed;
an extruder rail adjacent to the starting point of the conveying path;
the extruder rail extending in parallel with the conveying path and fixed relative to the base frame;
the extruder being movable along the extruder rail; and
a screw rod supported rotatably by the base frame and extending in parallel with the conveying path;
the extruder including a nut fixed thereto and engaging with the screw rod, so that the rotation of the rod positions the extruder relative to the molder.

26. An apparatus according to claim 4, and further comprising:
a base frame to which the molder is fixed;
an extruder rail adjacent to the starting point of the path;
the extruder rail extending in parallel with the conveying path and fixed relative to the base frame;
the extruder being movable along the extruder rail;
the extruder further including a screw rod supported rotatably thereby and extending in parallel with the conveying path; and
a nut fixed to the base frame and engaging with the screw rod, so that the rotation of the rod positions the extruder relative to the molder.

27. An apparatus according to claim 5, and further comprising:
a base frame to which the molder is fixed;
an extruder rail adjacent to the starting point of the path;
the extruder rail extending in parallel with the conveying path and fixed relative to the base frame;
the extruder being movable along the extruder rail;
the extruder further including a screw rod supported rotatably thereby and extending in parallel with the conveying path; and
a nut fixed to the base frame and engaging with the screw rod, so that the rotation of the rod positions the extruder relative to the molder.

28. An apparatus according to claim 6, and further comprising:
a base frame to which the molder is fixed;
an extruder rail adjacent to the starting point of the path;
the extruder rail extending in parallel with the conveying path and fixed relative to the base frame;
the extruder being movable along the extruder rail;
the extruder further including a screw rod supported rotatably thereby and extending in parallel with the conveying path; and
a nut fixed to the base frame and engaging with the screw rod, so that the rotation of the rod positions the extruder relative to the molder.

29. An apparatus according to claim 7, and further comprising:
a base frame to which the molder is fixed;
an extruder rail adjacent to the starting point of the path;
the extruder rail extending in parallel with the conveying path and fixed relative to the base frame;
the extruder being movable along the extruder rail;
the extruder further including a screw rod supported rotatably thereby and extending in parallel with the conveying path; and
a nut fixed to the base frame and engaging with the screw rod, so that the rotation of the rod positions the extruder relative to the molder.

30. An apparatus according to claim 8, and further comprising:
a base frame to which the molder is fixed;
an extruder rail adjacent to the starting point of the path;
the extruder rail extending in parallel with the conveying path and fixed relative to the base frame;
the extruder being movable along the extruder rail;
the extruder further including a screw rod supported rotatably thereby and extending in parallel with the conveying path; and
a nut fixed to the base frame and engaging with the screw rod, so that the rotation of the rod positions the extruder relative to the molder.

31. An apparatus according to claim 9, and further comprising:
a base frame to which the molder is fixed;
an extruder rail adjacent to the starting point of the path;
the extruder rail extending in parallel with the conveying path and fixed relative to the base frame;
the extruder being movable along the extruder rail;
the extruder further including a screw rod supported rotatably thereby and extending in parallel with the conveying path; and
a nut fixed to the base frame and engaging with the screw rod, so that the rotation of the rod positions the extruder relative to the molder.

32. An apparatus according to claim 4, wherein the T-die is divided into two parts.

33. An apparatus according to claim 5, wherein the T-die is divided into two parts.

34. An apparatus according to claim 6, wherein the T-die is divided into two parts.

35. An apparatus according to claim 7, wherein the T-die is divided into two parts.

36. An apparatus according to claim 8, wherein the T-die is divided into two parts.

37. An apparatus according to claim 9, wherein the T-die is divided into two parts.

38. An apparatus according to claim 4, wherein the T-die has a resin passage formed therethrough and includes an obstacle orthogonally protrudable into the passage.

39. An apparatus according to claim 5, wherein the T-die has a resin passage formed therethrough and includes an obstacle orthogonally protrudable into the passage.

40. An apparatus according to claim 6, wherein the T-die has a resin passage formed therethrough and includes an obstacle orthogonally protrudable into the passage.

41. An apparatus according to claim 7, wherein the T-die has a resin passage formed therethrough and includes an obstacle orthogonally protrudable into the passage.

42. An apparatus according to claim 8, wherein the T-die has a resin passage formed therethrough and includes an obstacle orthogonally protrudable into the passage.

43. An apparatus according to claim 9, wherein the T-die has a resin passage formed therethrough and includes an obstacle orthogonally protrudable into the passage.
